(19) United States
(12) Patent Application Publication
(10) Pub. No.: US 2014/0149574 A1
(43) Pub. Date: May 29, 2014

(54) GENERATING A GENERALIZED UNIFORM RESOURCE IDENTIFIER

(71) Applicant: HEWLETT-PACKARD DEVELOPMENT COMPANY, L.P., Houston, TX (US)

(72) Inventors: Piotr Findeisen, Rocklin, CA (US); Michael Haeuptle, Rocklin, CA (US)

(73) Assignee: HEWLETT-PACKARD DEVELOPMENT COMPANY, L.P., Houston, TX (US)

(21) Appl. No.: 13/687,584

(22) Filed: Nov. 28, 2012

(51) Int. Cl. H04L 12/26

(52) U.S. Cl. CPC H04L 43/04
USPC 709/224

(57) ABSTRACT

Examples disclosed herein relate to generating a generalized uniform resource identifier (URI). Examples include generating a generalized URI for a given URI. In examples disclosed herein, the generalized URI may include a generic value. Also, in examples disclosed herein, the generalized URI may include the generic value in a segment position corresponding to a variable segment position of the given URI.

### BACKGROUND

A computer network may include a server system comprising at least one server implementing a server application accessible to client system remote from the computer network. For example, the server application may implement a website accessible via a web browser of the client system. In such examples, the server system may receive requests from the client system, perform operations based on the requests, and provide responses to the client system. In some examples, a server monitoring tool may be used to monitor the performance of the server system.

### BRIEF DESCRIPTION OF THE DRAWINGS

The following detailed description references the drawings, wherein:

FIG. 1A is a block diagram of an example computing device to generate a generalized uniform resource identifier (URI);

FIG. 1B is a diagram of an example plurality of URIs and a generalized URI generated based on the example plurality of URIs;

FIG. 2A is a diagram of an example computing device to store a prefix tree representing at least some of a plurality of URIs;

FIG. 2B is a diagram of portions of an example plurality of URIs, at least some of which are represented by the prefix tree of FIG. 2A;

FIG. 2C is a diagram of the example prefix tree of FIG. 2A after adding an additional node;

FIG. 2D is a diagram of the example prefix tree of FIG. 2C after replacing a plurality of child nodes with a generic node;

FIG. 2E is a diagram of the example prefix tree of FIG. 2D after merging a plurality of child nodes having equivalent values;

FIG. 2F is a diagram of the example prefix tree of FIG. 2E after merging another plurality of child nodes having equivalent values;

FIG. 2G is a diagram of the example prefix tree of FIG. 2F after replacing another plurality of child nodes with a generic node;

FIG. 2H is a diagram of the example prefix tree of FIG. 2G after merging other pluralities of child nodes having equivalent values;

FIG. 3 is a block diagram of an example system to generate a generalized URI based on a prefix tree;

FIG. 4 is a flowchart of an example method for generating a generalized URI based on a prefix tree; and

FIG. 5 is a flowchart of an example method for providing a report associating a generalized URI with transaction information.

### DETAILED DESCRIPTION

As noted above, a server monitoring tool may be used to monitor the performance of a server system implementing a server application accessible to a client system. The server system may include at least one server, and the server application may implement a website, for example. In some examples, the server system may perform an operation in response to a request received from a client system in accordance with a protocol (e.g., the hypertext transfer protocol (HTTP), etc.). Each such request may be referred to herein as a “server request.” After performing the operation, the server system may provide a response to the requesting client system.

In some examples, for each server request received by the server system, the server monitoring tool may collect data associated with the server request, such as the latency of the server request. In some examples, client systems may provide each server request to the server system in the form of a uniform resource identifier (URI), such as a uniform resource locator (URL). In such examples, the server monitoring tool may associate the data collected in relation to a particular server request with the URI of the server request. The server monitoring tool may process the data collected for server requests having the same URI to obtain performance statistics for a particular type of server request. For example, the server monitoring tool may calculate a mean latency for server requests having the same URI, establish a performance baseline for such server requests, and subsequently indicate when server system performance in relation to such server requests deviates from the established baseline.

However, the URIs of some HTTP server requests may include information identifying both a requested operation (e.g., a search, purchase, update, etc.) and arguments for the requested operation. For example, in accordance with some styles of HTTP request structuring, such as the Representational State Transfer (REST) style, arguments for a server request may be interleaved with other parts of the URI. The arguments in such URIs may have a large number potential values, which may lead to the server system receiving a large number of different URIs for a single type of server request. In such examples, it may be difficult for the server monitoring tool to calculate useful statistics on the server system performance for a particular type of request, as the different URIs may appear to the server monitoring tool as unrelated server requests. For example, it may be difficult for the server monitoring tool to correlate the large number of different URIs with the same type of server request.

As an example, “http://www.z.com/bid/11/item/22/revoke” is an example REST style URI that includes numerical strings “11” and “22” as arguments identifying a user and an item, respectively. The example URI may represent, for example, a request to revoke a bid on an item associated with identifier “22” for a user associated with identifier “11”. There may be a large number of users or items, or both, which may lead to a large number of different URIs being used for server requests to revoke a bid. In such examples, it may be difficult for the server monitoring tool to calculate meaningful statistics on the server system performance in relation to server requests to revoke bids, as it may be difficult for the server system to correlate the large number of different URIs used for the server requests.

To address these issues, examples described herein may generate a generalized URI for a given URI. Some examples may further associate performance information related to the given URI with the generalized URI. For example, examples described herein may identify, as a variable segment position of a plurality of uniform resource identifiers (URIs), a segment position common to each of the URIs and having a threshold number of different values in the plurality of URIs. Examples described herein may further generate a generalized URI for a given one of the URIs, wherein the generalized URI includes a generic value in a segment position corresponding to the variable segment position of the given URI. Examples described herein may further provide, to a data aggregator, a report associating the generalized URI with performance information related to the given URI.

In this manner, examples described herein may enable a server monitoring tool to correlate server requests of the same type, regardless of the presence of embedded arguments in server request URIs. For example, examples described herein may generate generalized URIs having generic values in place of the embedded arguments to enable the monitoring tool to correlate URIs for the same type of server request, regardless of the embedded arguments. In such examples, the server monitoring tool may calculate statistics for particular types of server requests based on the performance information associated with equivalent generalized URIs. For example, examples described herein may generalize URIs having the format of the above example URI to “http://www.z.com/bid/*/item/*/revoke,” such that the server monitoring tool may correlate performance information associated with server requests to revoke a bid, regardless of argument values embedded in the URI.

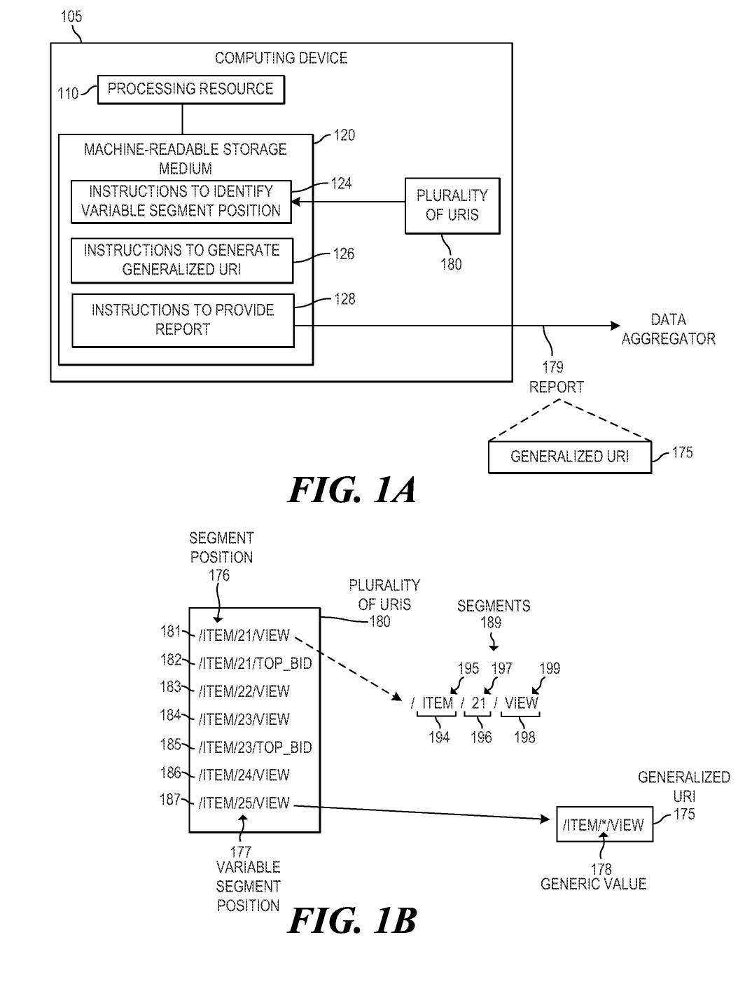

Referring now to the drawings, FIG. 1A is a block diagram of an example computing device 105 to generate a generalized uniform resource identifier (URI) 175. As used herein, a “computing device” may be a server, computer networking device, chip set, desktop computer, notebook computer, workstation, or any other processing device or equipment. In the example of FIG. 1A, computing device 105 includes a processing resource 110 and a machine-readable storage medium 120 encoded with instructions 124, 126, and 128. In some examples, storage medium 120 may include additional instructions. In other examples, instructions 124, 126, 128, and any other instructions described herein in relation to storage medium 120 may be stored on a machine-readable storage medium remote from but accessible to computing device 105 and processing resource 110.

In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processing resource 110 may fetch, decode, and execute instructions stored on storage medium 120 to implement the functionalities described below. In other examples, the functionalities of any of the instructions of storage medium 120 may be implemented in the form of electronic circuitry, in the form of executable instructions encoded on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. Further, any machine-readable storage medium described herein may be non-transitory.

In some examples, computing device 105 may implement at least a portion of a server monitoring tool to monitor the performance of a server system. For example, instructions 124, 126, 128 may be part of a larger set of instructions implementing a diagnostics agent of a server monitoring tool. In such examples, the diagnostics agent may monitor the performance of a server application implemented by the server system. In some examples, the diagnostics agent and the server application monitored by the diagnostics agent may be implemented by computing device 105. For example, the diagnostics agent and the monitored server application may be run by a virtual machine (e.g., the same virtual machine) hosted on computing device 105. The server application may implement a website or other application accessible by remote client systems, and may perform operations in response to server requests received from the client systems. In examples described herein, each server request includes a URI (e.g., a URL) that, alone or in combination with other information, specifies an action to be performed by the server application in response to the server request.

In such examples, the diagnostics agent may collect performance information in relation to each server request. As used herein, “performance information” related to a server request is information indicating at least one aspect of the performance of a server system in responding to the server request. Performance information for a sever request may include, for example, at least one of server request latency (i.e., the elapsed time between the server system receiving the server request and sending the response to the request), CPU consumption associated with the server request, a record of an exception or error code resulting from processing the server request, or the like. The diagnostics agent may provide the collected performance information to a data aggregator to calculate statistics for particular types of server requests. However, as noted above, URIs including embedded arguments may make it difficult for a server monitoring tool that identifies server requests by their respective URIs to correlate server requests of a particular type. As such, examples described herein may generate generalized URIs. Also, while some examples are described herein in the context of a server monitoring tool, examples described herein may be utilized in or with any other suitable system as well, such as a traffic monitoring tool, or in any other system that aggregates data in relation to URIs.

In the example of FIG. 1A, instructions 124 may acquire a plurality of URIs 180. In some examples, instructions 124 may acquire the plurality of URIs 180 from a monitored server application, via monitoring traffic exchanged with the server application, or in any other suitable manner. In other examples, instructions 124 may acquire URIs 180 from outside of computing device 105. In some examples, instructions 124 may acquire each of URIs 180 individually (e.g., sequentially as the URIs are received by the server application). Features of the example of FIG. 1A are described below in relation to the example plurality of URIs 180 illustrated in FIG. 1B.

FIG. 1B is a diagram of an example plurality of URIs 180 and a generalized URI 175 generated based on the example plurality of URIs 180. In the example of FIG. 1B, the plurality of URIs 180 includes URIs 181-187. Each of URIs 181-187 is a character string having a plurality of segments. As used herein, a “segment” of a URI is a portion of the URI having a value and located at a segment position of the URI. In examples described herein, a value of a segment of a URI is the substring of the URI represented by the segment. The value of a segment may be referred to as a “segment value” herein. Also, as used herein, a “segment position” of a URI is the location of a segment in the URI. In examples described herein, a given segment position of a URI may be defined by the sequence of segment values preceding the given segment position in the URI. As used herein, a sequence of segment values preceding a given segment position in a URI is the sequence of segment values represented by the sequence of segments preceding the given segment position. In examples described herein, a segment position including a given segment in a URI may be referred to herein as the segment position “of” the given segment.

For example, as illustrated in FIG. 1B, URI 181 comprises character string “/item/21/view”, including segments 189. In examples described herein, the segments of a URI may be the portions of the URI separated by a slash (“/”). In such examples, the segments of a URI may be determined based on the respective locations of slashes in the URI. In other examples, the segments of a URI may be determined in any other suitable manner. In the example of FIG. 1B, URI 181 includes a segment 194 having a value 195 of “item”, a segment 196 having a value 197 of “21”, and a segment 198 having a value 199 of “view”. As an example, the segment position of segment 198 is defined by the sequence of values (i.e., “item”, “21”) represented by the sequence of segments (i.e., segments 194, 196) preceding the segment position of segment 198 in URI 181. In the example of FIGS. 1A-1B, each of URIs 180 may be a portion of a larger URI (e.g., “http://www.z.com/item/21/view” for URI 181). For example, each of URIs 180 may be a portion of a URI following at least a scheme name (e.g., “http:”) and a domain name (e.g., “www.z.com”). In some examples described herein, such leading portions of a URI may be removed from the URI prior to utilizing the URI in generating generalized URIs in accordance with examples described herein. In such examples, the portion of a URI remaining after the removal of such leading portions (e.g., scheme name, domain name, etc.) may be referred to herein as a “URI” and utilized in examples described herein to generate generalized URIs. In such examples, the generalized URI may also omit such leading portions of a URI. In other examples, the domain name may not be removed from the URIs, but may be treated as another segment of the URIs, for example.

In the example of FIG. 1A, instructions 124 may identify, as a variable segment position of the plurality of URIs 180, a segment position that is common to each of the URIs 180 and that has a threshold number of different values in the plurality of URIs. The threshold value may be any suitable number greater than one (e.g., 10, 25, 100, etc.) and may be configurable (e.g., a user may set a desired threshold number). In an example described below in relation to FIG. 1 B, the threshold number may be five. As used herein, a segment position has the threshold number of different values if the segment position has at least the threshold number of different values. As used herein, a segment position “common to” a plurality of URIs is a segment position that, in each of the plurality of URIs, is preceded by an equivalent sequence of segment values.

In the example of FIGS. 1A and 1B, instructions 124 may identify a segment position 176, preceded by no other segment for each of URIs 181-187, as a common segment position for each of URIs 181-187. Similarly, instructions 124 may identify a segment position 177, preceded by the sequence of values “item” (i.e., a sequence of one value) in each of URIs 181-187, as a common segment position for each of URIs 181-187. However, while segment position 176 is common to URIs 181-187, URIs 181-187 each have the same value at that segment position. As such, instructions 124 may determine that URIs 181-187 do not have the threshold number of different values at segment position 176.

In the example of FIGS. 1A and 1B, instructions 124 may determine that URIs 181-187 have the threshold number of different values (e.g., five) at segment position 177, namely values “21”, “22”, “23”, “24”, and “25”. As such, instructions 124 may identify segment position 177, common to each of URIs 181-187, as a variable segment position.

Instructions 126 may generate a generalized URI 175 for a given one of URIs 180, the generalized URI 175 including a generic value in a segment position corresponding to the variable segment position of the given URI. In the example of FIGS. 1A and 1B, instructions 126 may generate generalized URI 175 for URI 187. In some examples, the generalized URI 175 may represent URI 187, such as in a server monitoring tool, for example. As illustrated in FIG. 1B, generalized URI 175 may include a generic value 178 (“*”) in a segment position of generalized URI 175 corresponding to variable segment position 177 of URI 187. As used herein, a segment position of a generalized URI “corresponding to” a segment position of a given URI is a segment position of the generalized URI that is preceded by a sequence of segment values equivalent to the sequence of segment values preceding the segment position of the given URI.

In examples described herein, a generic value may be any value defined as generically representing any segment value. In examples described herein, the generic value may be any value defined as a wildcard value, such as “*”. In some examples, a segment following the generic value in generalized URI 175 is equivalent to a segment following the variable segment position in the given URI. For example, as illustrated in FIG. 1B, the segment following generic value 178 in generalized URI 175 is equivalent to a segment following variable segment position 177 in URI 187 (i.e., both have the segment value “view”).

Instructions 128 may provide, to a data aggregator, a report 179 associating generalized URI 175 with performance information related to the given URI. For example, in the example of FIGS. 1A and 1B, report 179 may associate generalized URI 175 with performance information related to URI 187 for which generalized URI 175 was generated. In some examples, the performance information may be provided with generalized URI 175 in report 179, or may be provided separately from report 179. In some examples, the data aggregator may be a component of the server monitoring tool store performance information in relation to URIs and generate and display statistical information based on the stored performance information. In examples described herein, the data aggregator may store at least some of the performance information in relation to generalized URIs, generated as described herein, such that the data aggregator may correlate server requests of the same type comprising different URIs.

In some examples, the performance information may be performance information measured in relation to at least one operation performed by the server system in response to a server request comprising the given URI. For example, the performance information may be related to at least one operation invoked, at least in part, by the given URI. In some examples, the performance information may include a server request latency for a server request comprising the given URI. In other examples, the performance information may be any combination of performance information, as described above, collected in relation to the given URI.

In some examples, instructions 124, 126, and 128 may be part of an installation package that, when installed, may be executed by processing resource 110 to implement the functionalities described herein in relation to instructions 124, 126, and 128. In such examples, storage medium 120 may be a portable medium, such as a CD, DVD, or flash drive, or a memory maintained by a server from which the installation package can be downloaded and installed. In other examples, instructions 124, 126, and 128 may be part of an application or applications already installed on computing device 105 including processing resource 110. In such examples, the storage medium 120 may include memory such as a hard drive, solid state drive, or the like.

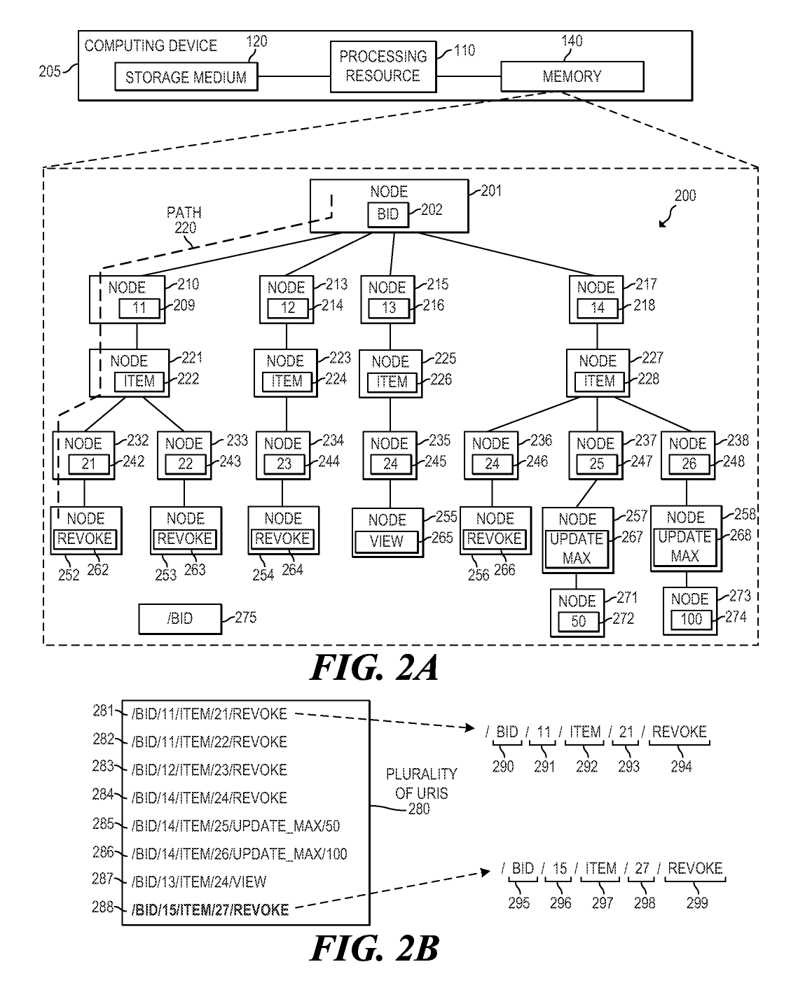

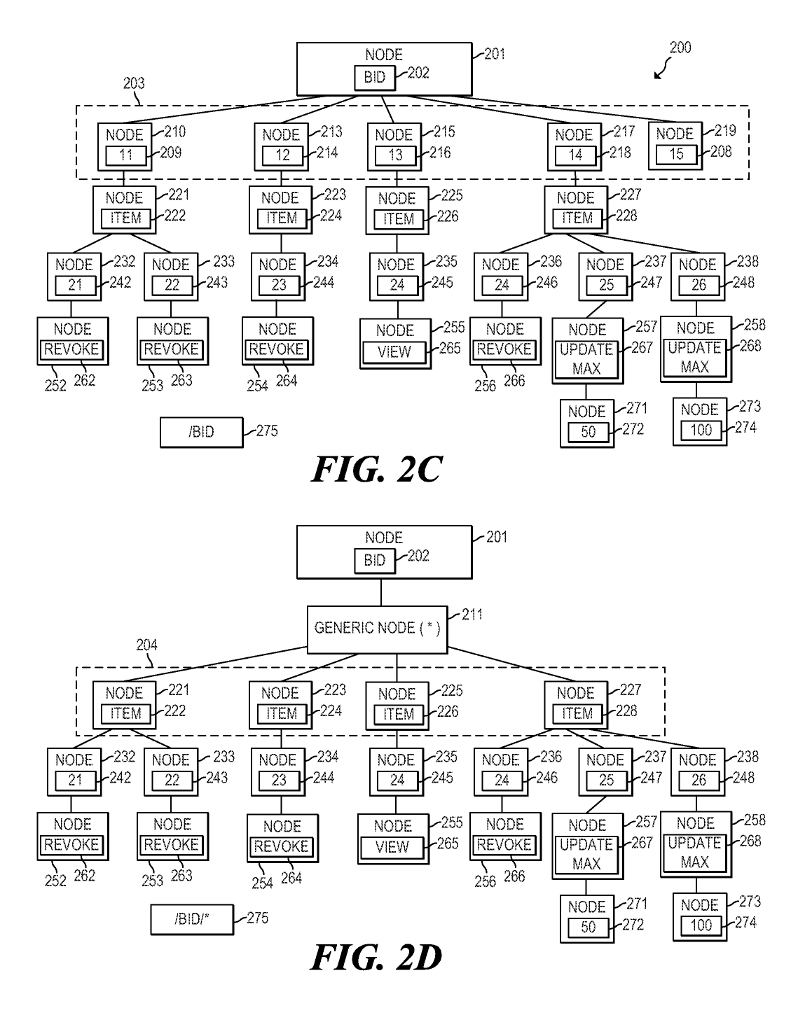

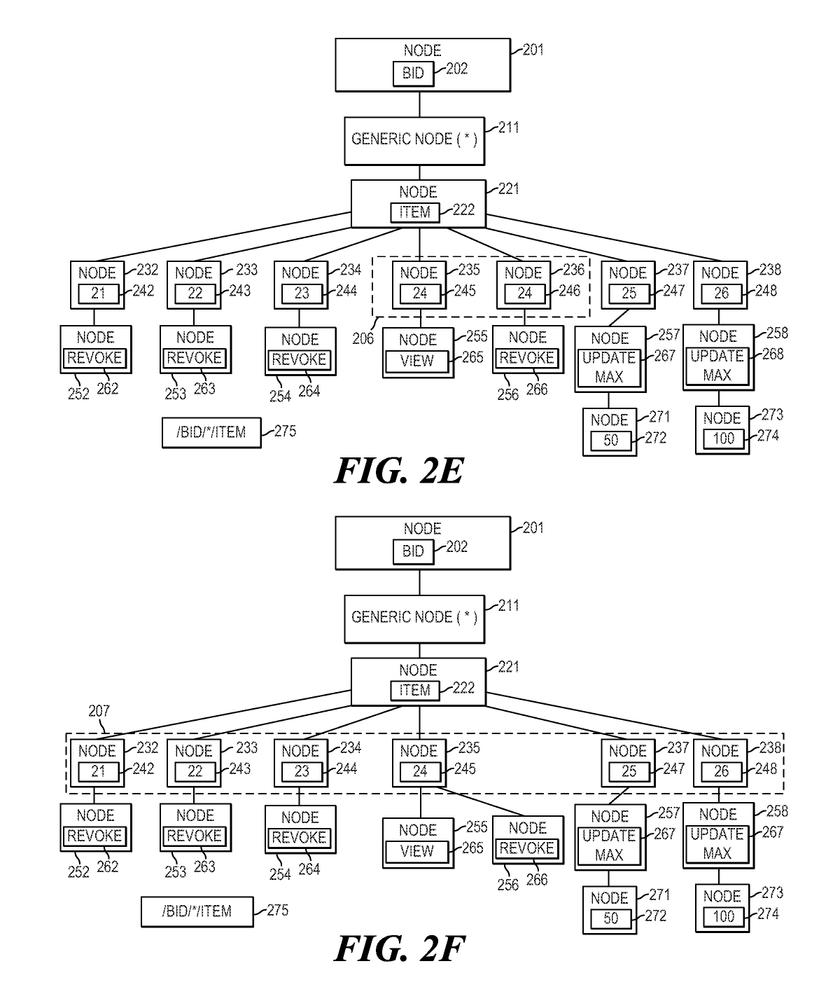

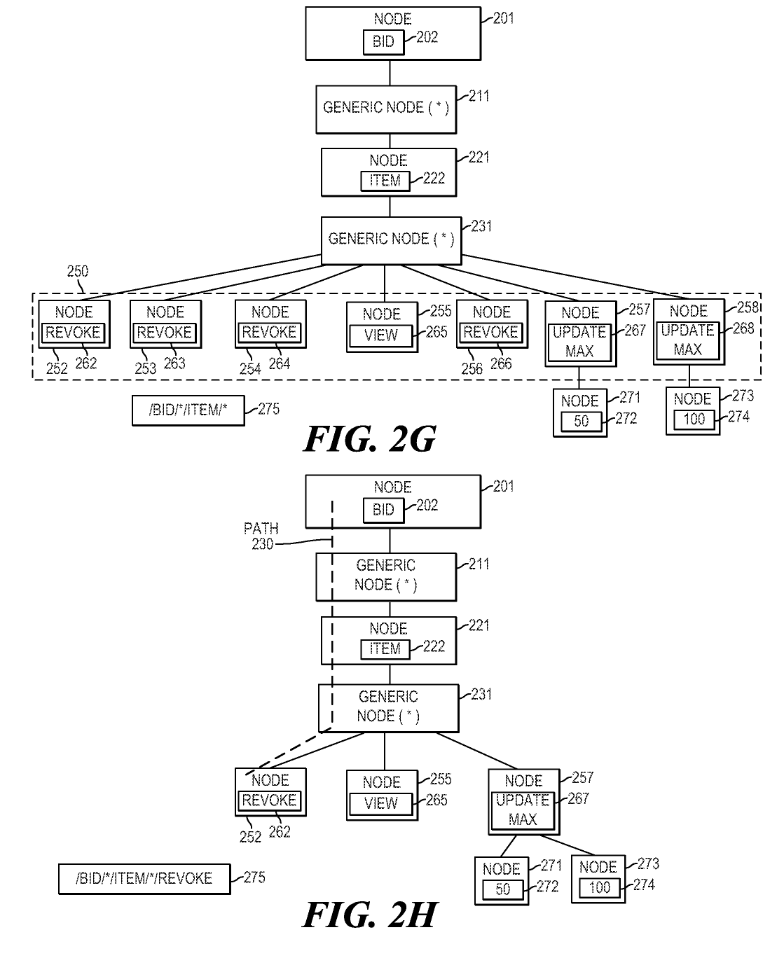

In some examples, functionalities described herein in relation to FIGS. 1A-1B may be provided in combination with functionalities described herein in relation to any of FIGS. 2A-5. Additionally, the functionalities of instructions 124, 126, and 128 may be implemented in a variety of different ways. An example implementation using a prefix tree (or “trie”) is described below in relation to FIGS. 2A-2H.

FIG. 2A is a diagram of an example computing device 205 to store a prefix tree 200 representing at least some of a plurality of URIs. In the example of FIG. 2A, computing device 205 includes a processing resource 110 and a machine-readable storage medium 120, as described above in relation to FIG. 1A. Computing device 205 also include a memory 140. Memory 140 may be a machine-readable storage medium. In some examples, storage medium 120 and memory 140 may be implemented by the same machine-readable storage medium. In other examples, memory 140 may be implemented by a machine-readable storage medium separate from storage medium 120.

As shown in FIG. 2A, memory 140 may store a prefix tree 200 representing a plurality of URIs. In examples described herein, a prefix tree is a tree data structure using nodes to represent segments of URIs, wherein, for each URI represented by the prefix tree, each segment of the URI is represented by a node in a different level of the tree. For example, for any given segment of each URI represented by the prefix tree, the given segment of the URI is represented by a given node at a given level, a segment immediately preceding the given segment of the URI is represented by the parent node of the given node, and a segment immediately following the given segment of the URI is represented by a child node of the given node.

Examples described herein may perform a “traversal” of (i.e., may “traverse”) a prefix tree representing a plurality of URIs in relation to a given URI starting from a current node and a current segment of the given URI. Such a traversal may include a search process comprising searching for a node matching the current segment among the child nodes of the current node. If such a child node is identified, then the search process may be repeated at the identified child node, with the next segment of the URI being the current segment and the identified child node being the current node. If no such child node is identified, then a new child node matching the current segment is created as a child node of the current node, and then the search process may be repeated at the new child node, with the next segment of the URI being the current segment and the new child node being the current node. In some examples, the traversal may start with a null root node of the prefix tree being the current node, and a first segment of the given URI being the current segment.

FIG. 2B is a diagram of portions of an example plurality of URIs 280. In the example of FIG. 2A, prefix tree 200 represents some of URIs 280, and each of the plurality of nodes of prefix tree 200 represents a segment of at least one of the URIs 280. In the example of FIGS. 2A-2B, each of URIs 280 may be a portion of a larger URI (e.g., “http://www.z.com/bid/11/item/21/revoke” for URI 281), as described above in relation to FIGS. 1A-1B. For example, each of URIs 280 may be a portion of a URI following at least one leading portion (e.g., a scheme name, a domain name, etc.) of a larger URI. In some examples, such leading portions of a URI may be removed from the URI prior to utilizing the URI in generating generalized URIs in accordance with examples described herein, as described above in relation to FIGS. 1A-1B.

In the example of FIG. 2A, storage medium 120 may include instruction 124, 126, and 128, as described above in relation to FIGS. 1A and 1B. In the example of FIGS. 2A-2B, instructions 124 may, for each of URIs 280, divide the URI into segments and insert the URI into prefix tree 200 with each segment represented by a node at a different level of the prefix tree. For example, instructions 124 may divide URI 281 into segments 290-294 and insert URI 281 into prefix tree 200 such that each of segments 290-294 is represented by a node at a different level of prefix tree 200. Each node in prefix tree 200 comprises a node value corresponding to at least one segment value of at least one of URIs 280.

FIG. 2A illustrates prefix tree 200 after inserting each of URIs 281-287 of URIs 280. Each URI represented by the prefix tree 200 is represented by a path of the prefix tree. As an example, URI 281 comprising segments 290-294 is represented by a path 220 including a node 201 having a value 202 equivalent to the value of segment 290, a node 210 having a value 209 equivalent to the value of next segment 291, a node 221 having a value 222 equivalent to the value of next segment 292, a node 232 having a value 242 equivalent to the value of next segment 293, and a node 252 having a value 262 equivalent to the value of next segment 294.

Additionally, URI 282 is represented by a path including nodes 201, 210, and 221, of path 220, and nodes 233 and 253 including values 243 and 263, respectively. URI 283 is represented by a path including node 201 and nodes 213, 223, 234, and 254 including values 214, 224, 244, and 264, respectively. URI 284 is represented by a path including node 201, and nodes 217, 227, 236, and 256 including values 218, 228, 246, and 266, respectively. URI 285 is represented by a path including nodes 201, 217, and 227, and nodes 237, 257, and 271 including values 247, 267, and 272, respectively. In addition, URI 286 is represented by a path including nodes 201, 217, and 227, and nodes 238, 258, and 273 including values 248, 268, and 274, respectively. Also, URI 287 is represented by a path including node 201, and nodes 215, 225, 235, and 255 including values 216, 226, 245, and 265, respectively.

In some examples, instructions 124 and 126 may utilize a prefix tree, such as prefix tree 200, to generate a generalized URI for a URI. For example, in the example of FIGS. 2A-2H, instructions 124 may acquire a URI 288 and divide URI 288 into at least segments 295-299. In some examples, instructions 124 may then traverse prefix tree 200 based on the segments of URI 288 and instructions 126 may generate a generalized URI for URI 288. In such examples, instructions 124 may first identify any nodes of prefix tree 200 matching (i.e., representing) any segments of URI 288 preceding segment 295 (not shown). Then, among the children of the last of such identified nodes, instructions 124 may determine that node 201 matches segment 295, since the value of segment 295 (“bid”) matches the value 202 (“bid”) of node 201.

In some examples, to form a generalized URI for a given URI, instructions 126 may concatenate at least the values associated with each node in a path of the prefix tree representing the given URI. In the example of FIGS. 2A-2H, to form a generalized URI 275 for URI 288, instructions 126 may concatenate at least the values associated with each node in a path of prefix tree 200 representing URI 288. In some examples, instructions 126 may construct the generalized URI one segment at a time as instructions 124 traverse prefix tree 200 for URI 288. For example, in the example of FIGS. 2A and 2B, after determining that node 201 matches segment 295, instructions 126 may append a leading slash and the value 202 of matching node 201 to the current, partial generalized URI 275, as shown in FIG. 2A. In some examples, generalized URI 275 may further include, before “Mid”, values of nodes previously matched with segments preceding segment 295 (separated by appropriate slashes). As shown in FIG. 2A, generalized URI 275 may be maintained in memory 140. After determining that segment 295 matches node 201, instructions 124 may determine that the next segment 296 of URI 288 does not match any of the child nodes 203 of node 201 (i.e., nodes 210, 213, 215, and 217). As such, instructions 124 may add a new node as a child node of node 201 and representing segment 296.

FIG. 2C is a diagram of the example prefix tree 200 of FIG. 2A after adding an additional node. In the example of FIGS. 2A-2H, instructions 124 may add a new node 219 as a child node of node 201. Node 219 may have a value 208 equivalent to the value of segment 296 (i.e., “15”). As described above in relation to FIGS. 1A-1B, instructions 124 may identify, as a variable segment position of a plurality of URIs, a segment position common to each of the URIs and having a threshold number of different values in the plurality of URIs. In the example of FIGS. 2A-2H, instructions 124 may identify, as a variable segment position of URIs 280, a segment position common to each of URIs 280 and having a threshold number of different values in URIs 280. In some examples, instructions 124 may identify such a variable segment position by identifying a node of prefix tree 200 that has the threshold number of child nodes. In such examples, instructions 124 may determine whether a current node of prefix tree 200 has the threshold number of child nodes. In the example of FIG. 2C, the threshold number may be five, for example. In such examples, instructions 124 may determine that node 201 has the threshold number of child nodes. In such examples, instructions 124 may thereby identify the segment position represented by the child nodes of node 201 as the variable segment position.

In addition, in response to a determination that a node has the threshold number of child nodes, instructions 124 may replace the child nodes with a generic node matching any segment value. In the example of FIG. 2C, in response to a determination that node 201 has the threshold number of child nodes 203, instructions 124 may replace child nodes 203 (i.e., nodes 210, 213, 215, 217, and 219) with a generic node matching any segment value.

FIG. 2D is a diagram of the example prefix tree 200 of FIG. 2C after replacing a plurality of child nodes 203 with a generic node 211. In the example of FIG. 2D, generic node 211 may match any segment value. In some examples, the generic node may include a flag indicating that it is a generic node. In such examples, when comparing any segment to generic node 211, instructions 124 may determine that the segment matches the node based on the presence of the flag indicating that node 211 is a generic node. In examples described herein, a segment “matches” a node (and vice versa) if either the value of the segment is equivalent to the value of the node, or the node is a generic node.

After replacing child nodes 203 with generic node 211, the path of prefix tree 200 representing URI 288 includes generic node 211, and instructions 126 may append a slash and a value associated with generic node 211 to generalized URI 275. For example, instructions 126 may append “/*” to generalized URI 275, if “*” is the generic value. In some examples, a generic value may be associated with each generic node of prefix tree 200, including generic node 211.

In examples described herein, after replacing a plurality of child nodes with a generic node, instructions 124 may make each child node, of each of the replaced child nodes, a child node of the generic node. In the example of FIG. 2D, instructions 124 may cause child nodes 204, of the collapsed child nodes 203, to be child nodes of generic node 211. In examples described herein, “collapsing” a plurality of child nodes into a generic node includes replacing the child nodes with the generic node and causing the child nodes of the replaced nodes to be child nodes of the generic node.

In some examples, after collapsing a plurality of child nodes into a generic node, instructions 124 may merge any child nodes of the generic node having equivalent values. In the example of FIG. 2D, all of child nodes 204 have the same value (“item”), so instructions 124 may merge child nodes 204 into one merged node.

FIG. 2E is a diagram of the example prefix tree 200 of FIG. 2D after merging a plurality of child nodes 204 having equivalent values. In some examples, merging a plurality of nodes having the same value may include removing all but one of the merged nodes, and making all of the child nodes of the merged nodes child nodes of the remaining merged node. For example, in the example of FIGS. 2A-2H, instructions 124 may merge child nodes 204 into a merged node 221. In such examples, instructions 124 may remove nodes 223, 225, and 227, and make the child nodes of nodes 223, 225, and 227 child nodes of node 221 as part of the merge operation.

In some examples, after merging a plurality of child nodes into a single node, instructions 124 may determine, based on the threshold, whether to collapse any remaining child nodes. In the example of FIG. 2E, there is only one child node of generic node 211 remaining, so no collapse is performed. After merging child nodes 204 into node 221, instructions 124 may determine that next segment 297 of URI 288 matches node 221. In such examples, the path of prefix tree 200 representing URI 288 includes node 221, and instructions 126 may append a slash and the value 222 (“item”) of node 221 to generalized URI 275.

Additionally, in some examples, after determining that segment 297 matches node 221, instructions 124 may consider the child nodes of node 221. In such examples, instructions 124 may first merge any child nodes of the node 221 having equivalent values. In the example of FIG. 2E, child nodes 206 have the same value (“24”), so instructions 124 may merge child nodes 206 into one merged node.

FIG. 2F is a diagram of the example prefix tree 200 of FIG. 2E after merging another plurality of child nodes 206 having equivalent values. In the example of FIGS. 2A-2H, instructions 124 may merge child nodes 206 into a single node 235. After the merge, instructions 124 may then determine that node 221 has the threshold number of child nodes. As used herein, a node has the threshold number of child nodes if it has at least the threshold number of child nodes. In the example of FIG. 2F, the threshold number may be five, and node 221 has six child nodes, so instructions 124 may determine that node 221 has the threshold number of child nodes. In response to the determination, instructions 124 may replace the child nodes 207 with a generic node matching any segment value.

FIG. 2G is a diagram of the example prefix tree 200 of FIG. 2F after replacing another plurality of child nodes 207 with a generic node 231. In the example of FIGS. 2A-2H, instructions 124 may collapse child nodes 207 into a generic node 231 associated with a generic value, as described above in relation to FIG. 2D. After replacing child nodes 207 with generic node 231, instructions 124 may determine that next segment 298 of URI 288 matches generic node 231. In such examples, the path of prefix tree 200 representing URI 288 includes generic node 231, and instructions 126 may append a slash and a value associated with generic node 231 (e.g., a generic value “*”) to generalized URI 275.

In some examples, after collapsing child nodes 207 into generic node 231, instructions 124 may merge any child nodes 250 of generic node 231 having equivalent values. In the example of FIG. 2G, instructions 124 may merge child nodes 252, 253, 254, and 256 having the same value (“revoke”), and may merge child nodes 257 and 258 having the same value (“update_max”).

FIG. 2H is a diagram of the example prefix tree 200 of FIG. 2G after merging other pluralities of child nodes having equivalent values. In the example of FIGS. 2A-2H, instructions 124 may merge child nodes 252, 253, 254, and 256 into a merged node 252, and may merge child nodes 257 and 258 into a merged node 258. After merging the child nodes, instructions 124 may determine that next segment 299 of URI 288 matches node 252. In such examples, the path 230 of prefix tree 200 representing URI 288 includes node 252, and instructions 126 may append a slash and the value 262 (“revoke”) of node 221 to generalized URI 275. In some examples, instructions 124 may then cease traversing prefix tree 200, as all segments of URI 288 have been matched to a node of prefix tree 200. In such examples, instructions 128 may provide to the data aggregator a report 178 associating the generalized URI 275 generated by instructions 126 for URI 288 with performance information related to URI 288.

In examples described herein, instructions 124 may proceed down a prefix tree for a given URI recursively, or in any other suitable manner. As instructions 124 proceed down a prefix tree for a given URI, instructions may, at each level of the prefix tree, perform merge operations, collapse operations, and operations comparing segments to nodes as appropriate. In some examples, instructions 124 may merge child nodes of a given node, as appropriate, prior to determining whether the given node has the threshold number of child nodes.

In examples described herein, by using a prefix tree to generate a generalized URI for a given URI, generalized URIs may be generated for acquired URIs dynamically, based on the URIs that have been considered previously, without any predefined URI transformation rules. Additionally, unlike predefined URI transformation rules, examples described herein may continue to operate without manual reconfiguration in the event that URI structure, style or the like changes. In some examples, functionalities described herein in relation to FIGS. 2A-2H may be provided in combination with functionalities described herein in relation to any of FIGS. 1A-1 B and 3-5.

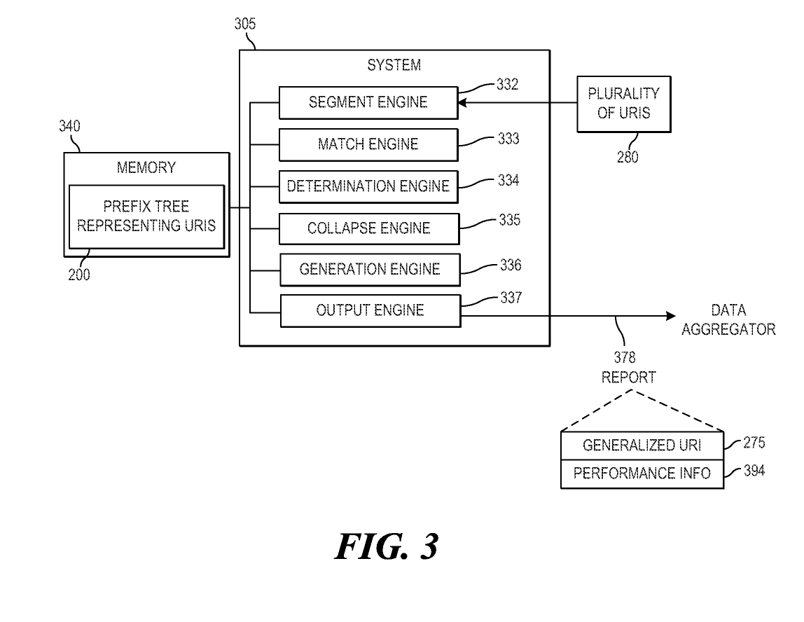

FIG. 3 is a block diagram of an example system 305 to generate a generalized URI based on a prefix tree. In the example of FIG. 3, system 305 includes engines 332-337 in communication with a memory 340 to store a prefix tree to represent a plurality of URIs. Memory 340 may be a machine-readable storage medium. In some examples, system 305 may include additional engines.

Each of engines 332-337, and any other engines of system 305, may be any combination of hardware and programming to implement the functionalities of the respective engine. Such combinations of hardware and programming may be implemented in a number of different ways. For example, the programming may be processor executable instructions stored on a non-transitory machine-readable storage medium and the hardware may include a processing resource to execute those instructions. In such examples, the machine-readable storage medium may store instructions that, when executed by the processing resource, implement system 305. The machine-readable storage medium storing the instructions may be integrated in the same computing device as the processing resource to execute the instructions, or the machine-readable storage medium may be separate but accessible to the computing device and the processing resource. The machine-readable storage medium storing the instructions may be separate from memory 340. In other examples, the machine-readable storage medium storing the instructions may be implemented by the same machine-readable storage medium. The processing resource may one processor or multiple processors included in a single computing device or distributed across multiple computing devices. Also, in some examples, memory 340 may be integrated in the same computing device as at least one processor of the processing resource or separate from but accessible to at least one of the processors of the processing resource.

In some examples, the instructions can be part of an installation package that, when installed, can be executed by the processing resource to implement system 305. In such examples, the machine-readable storage medium may be a portable medium, such as a CD, DVD, or flash drive, or a memory maintained by a server from which the installation package can be downloaded and installed. In other examples, the instructions may be part of an application or applications already installed on a computing device including the processing resource. In such examples, the machine-readable storage medium may include memory such as a hard drive, solid state drive, or the like.

In the example of FIG. 3, system 305 may acquire a plurality of URIs as described above in relation to FIG. 1A, and may generate a prefix tree to represent at least some of the URIs. As one example, system 305 may acquire the plurality of URIs 280, described above in relation to FIGS. 2A-2H, and may generate and store in memory 340 a prefix tree 200, as described above in relation to FIG. 2A, representing at least URIs 281-287 of URIs 280. In some examples, segment engine 332 may acquire URIs 280 individually or in at least one group.

In the example of FIG. 3, after generating a prefix tree representing URIs, system 305 may acquire a particular URI and traverse the prefix tree based on the particular URI and generate a generalized URI for the particular URI. In such examples, segment engine 332 may acquire the particular URI and divide the particular URI into a plurality of segments. For example, segment engine 332 may acquire URI 288 and divide URI 288 into a plurality of segments including at least segments 295-299.

In such examples, match engine 333 may traverse the prefix tree based on the plurality of segments and match engine 333 may, as part of the traversal of the prefix tree, compare the respective segments of the particular URI to respective nodes along a path of the prefix tree and, for each segment, determine that the segment matches a node of prefix tree if either the value of the node is equivalent to the value of the segment or the node is a generic node. For example, match engine 333 may traverse prefix tree 200 based on the plurality of segments of URI 288, as described above in relation to FIGS. 2A-2H. In such examples, match engine 333 may, as part of a traversal of prefix tree 200, compare the respective segments of URI 288 to respective nodes along a path of prefix tree 200. Match engine 333 may also add a new child node each time a child node of the current node does not match the current segment of the URI. For example, as shown in FIG. 2C, match engine 333 may add a new child node 219 to prefix tree 200 to represent segment 296 of URI 288.

In the example of FIG. 3, while traversing a prefix tree in relation to the particular URI, determination engine 334 may determine whether the current node of the prefix tree has a threshold number of child nodes. In response to a determination that the current node has the threshold number of child nodes, collapse engine 335 may collapse the child nodes of the current node into a generic node associated with a generic value and representing a variable segment position of the URIs. For example, as illustrated in FIGS. 2C-2D, engine 335 may collapse child nodes 203 into a generic node 211 associated with a generic value (e.g., “*”).

Also, in the example of FIG. 3, generation engine 336 may generate, based on the prefix tree with the generic node, a generalized URI for the particular URI. In such examples, the generalized URI may include the generic value in a segment position corresponding to the variable segment position of the particular URI. For example, as shown in FIGS. 2A-2H, generation engine 336 may generate a generalized URI 275 for URI 288 based on a path 230 of prefix tree 200 including generic nodes 211 and 231. In some examples, generation engine 336 may generate the generalized URI as match engine traverses prefix tree 200.

In the example of FIG. 3, output engine 337 may provide, to a data aggregator, a report 378 associating the generalized URI with performance information related to the particular URI for which the generalized URI was generated. For example, output engine 337 may provide, to a data aggregator, a report 378 associating generalized URI 275 with performance information 394 related to URI 288. In some examples, the report 378 may include both the generalized URI 275 and the performance information 394.

As noted above, in response to a determination that the current node has the threshold number of child nodes, collapse engine 335 may collapse the child nodes of the current node into a generic node. In some examples, after the collapse of the child nodes of a node, each child node of each of the collapsed nodes is a child node of the generic node. In the example of FIG. 3, collapse engine 335 may further merge any child nodes of the generic node having equivalent values, as shown in FIGS. 2D-2E, for example. Collapse engine 335 may further collapse the child nodes of the generic node, if the generic node has the threshold number of child nodes after the merging of any child nodes having equivalent values. In some examples, during the traversal of a prefix tree for a particular URI, at each level of the prefix tree (i.e., at a current node), match engine 333 may add a child node to represent an unrepresented segment, collapse engine 335 may merge child nodes having equivalent values, and collapse engine 335 may collapse child nodes if the number of child nodes is at least an appropriate threshold number, or any combination thereof. In some examples, at each level of the prefix tree, collapse engine 335 may merge any equivalent child nodes prior to collapsing child nodes (and prior to determination engine 334 determining whether the number of child nodes is at least the appropriate threshold number).

In some examples, determination engine 334 may use the same threshold number of child nodes at each node of the prefix tree. In other examples, determination engine 334 may utilize different threshold numbers at different levels of the prefix tree. For example, determination engine 334 may utilize a smaller threshold number at a lower level of the prefix tree than at a higher level of the prefix tree. In examples described herein, a level of a prefix tree may be the node or set of nodes at a given distance from the root of the prefix tree.

For example, determination engine 334 may determine whether a first node of the prefix tree has a first threshold number of child nodes and may subsequently determine whether a second node of the prefix tree has a second threshold number of child nodes, wherein the given node and the other node are at different levels of the prefix tree, and the first and second threshold numbers are different. In such examples, if engine 334 determines that the first node has the first threshold number of child nodes, collapse engine 335 may collapse the child nodes of the first node. Additionally, if, at a subsequent level of the prefix tree, engine 334 determines that the second node has the second threshold number of child nodes, collapse engine 335 may collapse the child nodes of the second node. For example, referring to FIG. 2C, determination engine 334 may determine that node 201 has at least a first threshold number of child nodes (e.g., 5) and, referring to FIG. 2F, engine 334 may subsequently determine that node 221 has at least a second threshold number of child nodes (e.g., 4).

In other examples, determination engine 334 may use different threshold numbers of child nodes at different nodes at the same level of the prefix tree. In such examples, determination engine 334 may determine the threshold number to utilize at a given node based on the value of the node. For example, determination engine 334 may utilize a different threshold number at a node having the value “bid” than at a node having the value “item”, even if those nodes at the same level of the prefix tree.

For example, determination engine 334 may determine whether a first node of the prefix tree has a first threshold number of child nodes and may determine whether a second node of the prefix tree has a second threshold number of child nodes, wherein the given node and the other node are at the same level of the prefix tree, and respective amounts of the first and second threshold numbers are different and are based on the respective values of the first and second nodes. In such examples, if engine 334 determines that the first node has the first threshold number of child nodes, collapse engine 335 may collapse the child nodes of the first node. Additionally, if engine 334 determines that the second node has the second threshold number of child nodes, collapse engine 335 may collapse the child nodes of the second node.

While system 305 has been described above in relation to example plurality of URIs 280, the functionalities of system 305 described above may be performed in relation to any other plurality of URIs. In some examples, functionalities described herein in relation to FIG. 3 may be provided in combination with functionalities described herein in relation to any of FIGS. 1A-2H and 4-5.

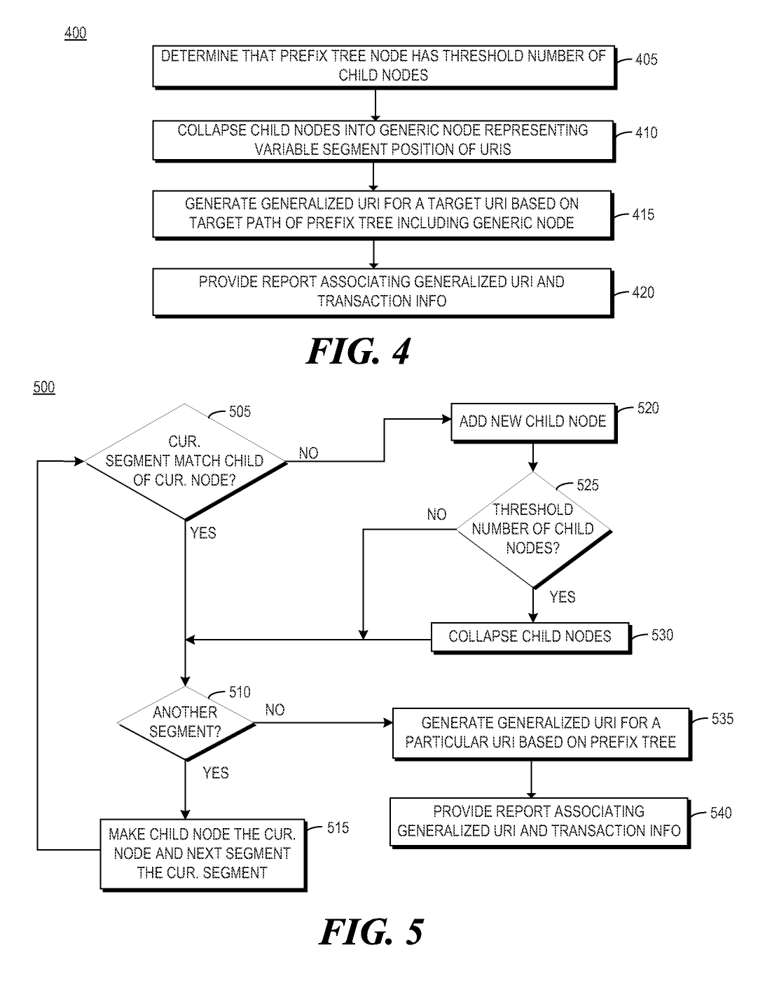

FIG. 4 is a flowchart of an example method 400 for generating a generalized URI based on a prefix tree. Although execution of method 400 is described below with reference to system 305 of FIG. 3, other suitable systems for execution of method 400 can be utilized (e.g., computing device 105). Additionally, implementation of method 400 is not limited to such examples.

At 405 of method 400, determination engine 334 may determine that a current node of a plurality of nodes of a prefix tree has a threshold number of child nodes. In such examples, the prefix tree may represent at least some of a plurality of URIs, and each of the plurality of nodes may represent a segment of at least one of the URIs. In response to the determination, collapse engine 335 may collapse the child nodes of the current node into a generic node at 410. The generic node may be associated with a generic value and may represent a variable segment position of the URIs.

At 415, generation engine 336 may generate a generalized URI for a particular one of the URIs based on a path of the prefix tree representing the particular URI. In such examples, the path may include the generic node and the generalized URI may include the generic value in a segment position corresponding to the variable segment position of the particular URI. In some examples, the generation of the generalized URI at 415 may be performed at least partially concurrently with the functionalities associated with blocks 405 and 410. At 420, output engine 337 may provide, to a data aggregator, a report associating the generalized URI with performance information related to the particular URI.

Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. In some examples, functionalities described herein in relation to FIG. 4 may be provided in combination with functionalities described herein in relation to any of FIGS. 1A-3 and 5.

FIG. 5 is a flowchart of an example method for providing a report associating a generalized URI with transaction information. Although execution of method 500 is described below with reference to system 305 of FIG. 3, other suitable systems for execution of method 500 can be utilized (e.g., computing device 105). Additionally, implementation of method 500 is not limited to such examples. In examples described herein, method 500 may be performed in relation to a prefix tree representing at least some of a plurality of uniform resource identifiers (URIs), wherein the prefix tree includes a plurality of nodes each representing a segment of at least one of the URIs.

At 505 of method 500, match engine 333 may determine whether a current segment of a particular URI of the plurality of URIs matches any child node of a current node of the prefix tree. If so, method 500 may proceed to 510, where match engine 333 may determine whether the particular URI includes another segment after the current segment. If so, at 515, match engine 333 may make the matching child node the current node and may make the next segment of the URI the current segment. Method 500 may then proceed to 505.

In some examples, match engine 333 may determine at 505 that the current node has no child node matching the current segment of the particular URI. In such examples, method 500 may proceed to 520, where match engine 333 may add a new node to the prefix tree as a child of the current node. In such examples, the new node may have a value equivalent to a value of the current segment. After the new node is added, method 500 may proceed to 525, where determination engine 334 may determine whether the current node has a threshold number of child nodes. If not, then method 500 may proceed to 510. If so, then in response to the determination, method 500 may proceed to 530, where collapse engine 335 may collapse the child nodes of the current node into a generic node associated with a generic value and representing a variable segment position of the URIs.

After the child nodes are collapsed at 530, method 500 may proceed to 510, where match engine may determine whether the particular URI includes a next segment following the current segment. If so, method 500 may proceed to 515, where match engine may make the next segment the current segment and make the generic node the current node. Method 500 may then proceed to 505, where match engine 333 may determine whether the next segment of the particular URI, following the current segment, matches any child node of the generic node, in examples in which the next segment has been made the current segment and the generic node has been made the current segment at 515.

In the example of FIG. 5, if it is determined at 510 that there is no next segment following the current segment of the particular URI, method 500 may proceed to 535, where generation engine 336 may generate a generalized URI for the particular URI based on a path of the prefix tree representing the particular URI. In some examples, the path may include the generic node and the generalized URI may include the generic value in a segment position corresponding to the variable segment position of the particular URI. In some examples, generation engine 336 may generate the generalized URI at least partially concurrently with the functionalities described above in relation to 505-530. At 540, output engine 337 may provide, to a data aggregator, a report associating the generalized URI with performance information related to the particular URI.

Although the flowchart of FIG. 5 shows a specific order of performance of functionalities of method 500, method 500 is not limited to that order. For example, the functionalities shown in succession in the flowchart may be performed in a different order, may be executed concurrently or with partial concurrence, or a combination thereof. In some examples, functionalities described herein in relation to FIG. 5 may be provided in combination with functionalities described herein in relation to any of FIGS. 1A-4.

What is claimed is:

1. A non-transitory machine-readable storage medium encoded with instructions executable by a processing resource of a computing device to:
identify, as a variable segment position of a plurality of uniform resource identifiers (URIs), a segment position common to each of the URIs and having a threshold number of different values in the plurality of URIs;
generate a generalized URI for a given one of the URIs, the generalized URI including a generic value in a segment position corresponding to the variable segment position of the given URI; and
provide, to a data aggregator, a report associating the generalized URI with performance information related to the given URI.

2. The storage medium of claim 1, wherein the performance information includes a server request latency for a server request comprising the given URI.

3. The storage medium of claim 1, wherein a segment following the generic value in the generalized URI is equivalent to a segment following the variable segment position in the given URI.

4. The storage medium of claim 1, wherein the instructions to identify comprise instructions to:
determine whether a given node of a plurality of nodes of a prefix tree has the threshold number of child nodes, wherein the prefix tree represents at least some of the URIs and each of the plurality of nodes represents a segment of at least one of the URIs.

5. The storage medium of claim 4, wherein the instructions to identify further comprise instructions to:
in response to a determination that the given node has the threshold number of child nodes, replace the child nodes of the given node with a generic node matching any segment value.

6. The storage medium of claim 5, wherein the instructions to generate comprise instructions to:
concatenate at least the values associated with each node in a path of the prefix tree representing the given URI, to form the generalized URI, the path including the generic node, wherein the generic node is associated with the generic value.

7. A system comprising:
a determination engine to determine whether a given node of a plurality of nodes of a prefix tree has a threshold number of child nodes, wherein the prefix tree represents at least some of a plurality of uniform resource identifiers (URIs) and each of the plurality of nodes represents a segment of at least one of the URIs;
a collapse engine to, in response to a determination that the given node has the threshold number of child nodes, collapse the child nodes of the given node into a generic node matching any segment value and representing a variable segment position of the URIs; and
a generation engine to generate, based on the prefix tree with the generic node, a generalized URI for a particular one of the URIs, the generalized URI including the generic value in a segment position corresponding to the variable segment position of the particular URI.

8. The system of claim 7, further comprising:
an output engine to provide, to a data aggregator, a report associating the generalized URI with performance information related to the particular URI.

9. The system of claim 7, wherein:
the determination engine is further to determine whether another node of the prefix tree has another threshold number of child nodes, wherein the given node and the other node are at different levels of the prefix tree, and the threshold number is different than the other threshold number; and
the collapse engine is further to, in response to a determination that the other node has the other threshold number of child nodes, collapse the child nodes of the other node into another generic node matching any segment value.

10. The system of claim 7, wherein:
the determination engine is further to determine whether another node of the prefix tree has another threshold number of child nodes, wherein the given node and the other node are at the same level of the prefix tree, and the amount of the other threshold number is based on at least a value of the other node; and
the collapse engine is further to, in response to a determination that the other node has the other threshold number of child nodes, collapse the child nodes of the other node into another generic node matching any segment value.

11. The system of claim 7, further comprising:
a segment engine to divide the particular URI into a plurality of segments; and
a match engine to, as part of a traversal of the prefix tree, compare the respective segments of the particular URI to nodes along a path of the prefix tree,
wherein the match engine is to determine that a respective one of the segments matches a respective node of the prefix tree if either a value of the respective node is equivalent to a value of the respective segment or the respective node is a generic node.

12. The system of claim 7, wherein:
after the collapse of the child nodes of the given node, each child node of each of the collapsed nodes is a child node of the generic node;
the collapse engine is further to merge any child nodes having equivalent values among the child nodes of another one of the nodes of the prefix tree; and
the collapse engine is further to collapse the child nodes of the other node, if the other node has the threshold number of child nodes after the merging of any child nodes having equivalent values.

13. A method comprising:
determining, with a determination engine, that a current node of a plurality of nodes of a prefix tree has a threshold number of child nodes, wherein the prefix tree represents at least some of a plurality of uniform resource identifiers (URIs) and each of the plurality of nodes represents a segment of at least one of the URIs;
in response to the determination, collapsing the child nodes of the current node into a generic node associated with a generic value and representing a variable segment position of the URIs;
generating a generalized URI for a particular one of the URIs based on a path of the prefix tree representing the particular URI, wherein the path includes the generic node and the generalized URI includes the generic value in a segment position corresponding to the variable segment position of the particular URI; and
providing, to a data aggregator, a report associating the generalized URI with performance information related to the particular URI.

14. The method of claim 13, further comprising:
determining that the current node has no child node matching a current segment of the particular URI; and
adding a new node to the prefix tree as a child of the current node, the new node having a value equivalent to a value of the current segment, wherein the determining that the current node has the threshold number of child nodes occurs after adding the new node.

15. The method of claim 14, further comprising:
after collapsing the child nodes, determining whether a next segment of the particular URI, following the current segment, matches any child node of the generic node.
